(19) United States
(12) Patent Application Publication
(10) Pub. No.: US 2020/0068141 A1
(43) Pub. Date: Feb. 27, 2020

(54) ELECTRONIC DEVICE AND PROGRAM

(71) Applicant: NIKON CORPORATION, Tokyo (JP)

(72) Inventors: Yuki KATSUMATA, Kawasaki-shi (JP); Naoki SEKIGUCHI, Yashio-shi (JP)

(73) Assignee: NIKON CORPORATION, Tokyo (JP)

(21) Appl. No.: 16/498,155

(22) PCT Filed: Sep. 29, 2017
(86) PCT No.: PCT/JP2017/035656

§ 371 Date: Sep. 26, 2019

(30) Foreign Application Priority Data
Mar. 31, 2017 (JP) 2017-071951

(51) Int. Cl. H04N 5/262; G06T 7/20; G06T 3/40

(52) U.S. Cl. CPC H04N 5/2628; G06T 2207/10016; G06T 3/40; G06T 7/20

(57) ABSTRACT

An electronic device that performs image-capturing and generates a moving image, includes: an image sensor that captures an image of a subject and outputs the moving image; and a generating unit that changes an image-capturing region of the image sensor generating the moving image to be displayed on a display unit, based on information on movement of the electronic device.

### TECHNICAL FIELD

The present invention relates to an electronic device and a program.

### BACKGROUND ART

An image-capturing device attached to a moving person or object to capture a moving image is known (see PTL1). Although the image-capturing device may move during image-capturing, photographing conditions for photographing during movement has been not taken into consideration.

### CITATION LIST

### Patent Literature

PTL1: Japanese Laid-Open Patent Publication No. 2012-205163

### SUMMARY OF INVENTION

According to the 1st aspect, an electronic device that performs image-capturing and generates a moving image, comprises: an image sensor that captures an image of a subject and outputs the moving image; and a generating unit that changes an image-capturing region of the image sensor generating the moving image to be displayed on a display unit, based on information on movement of the electronic device.

According to the 2nd aspect, an electronic device that performs image-capturing and generates a moving image, comprises: an image sensor that captures an image of a subject and outputs moving image data; and a generating unit that generates a moving image to be displayed on a display unit by compressing an image constituting the moving image based on the moving image data in at least one of a vertical direction and a horizontal direction, based on information on movement of the electronic device.

According to the 3rd aspect, an electronic device that processes a captured moving image, comprises: a reading unit that reads moving image data; and a generating unit that generates a moving image by processing the moving image data so as to change a display region of the moving image to be displayed on a display unit based on information on movement of the electronic device.

According to the 4th aspect, an electronic device that processes a captured moving image, comprises: a reading unit that reads moving image data; and a generating unit that generates a moving image to be displayed on a display unit by compressing an image constituting the moving image based on the moving image data in at least one of a vertical direction and a horizontal direction, based on information on movement of the electronic device.

According to the 5th aspect, a program executed by an electronic device that processes a captured moving image, executes: a first procedure of reading moving image data; and a second procedure of generating a moving image by processing the moving image data so as to change a display region of the moving image to be displayed on a display unit based on information on movement of the electronic device.

According to the 6th aspect, a program executed by an electronic device that processes a captured moving image, executes: a first procedure of reading moving image data; and a second procedure of generating a moving image to be displayed on a display unit by compressing an image constituting the moving image based on the moving image data in at least one of a vertical direction and a horizontal direction, based on information on movement of the electronic device.

According to the 7th aspect, an electronic device that generates moving image data, comprises: an image sensor that captures a subject and outputs moving image data; and a control unit that controls an image-capturing region of the image sensor based on information on movement of the electronic device.

### BRIEF DESCRIPTION OF DRAWINGS

FIG. 1 is a block diagram showing a configuration of a camera according to a first embodiment.

FIG. 2 is a view schematically showing a camera attached to the head of a skier who skis down a slope.

FIG. 3 is an example of an image in a frame of a moving image captured by a camera attached to the head of the skier shown in FIG. 2, showing a state of the slope.

FIG. 4 is a view of explaining compression processing.

FIG. 5 is view of explaining limitation of a change amount of a compression amount d.

FIG. 6 is a flowchart showing processing relating to image-capturing of the camera according to the first embodiment.

FIG. 7 is a view of explaining compression processing.

FIG. 8 is a view of explaining trimming processing.

FIG. 9 is a flowchart showing processing relating to image-capturing of the camera according to a third embodiment.

FIG. 10 is a view of explaining cropping processing.

FIG. 11 is a flowchart showing processing relating to image-capturing of the camera 1 according to a fourth embodiment.

FIG. 12 is a view showing white balance adjustment processing.

FIG. 13 is a flowchart showing processing relating to image-capturing of the camera 1 according to a fifth embodiment.

FIG. 14 is a view of explaining color tone correction processing.

FIG. 15 is a flowchart showing processing relating to image-capturing of the camera 1 according to a sixth embodiment.

FIG. 16 is a view of explaining color tone correction processing.

FIG. 17 is a block diagram showing a configuration of a camera and a personal computer according to an eighth embodiment.

FIG. 18 schematically shows a comparative example of moving subjects.

FIG. 19 illustrates an adjustment interface during reproduction.

### DESCRIPTION OF EMBODIMENTS

### First Embodiment

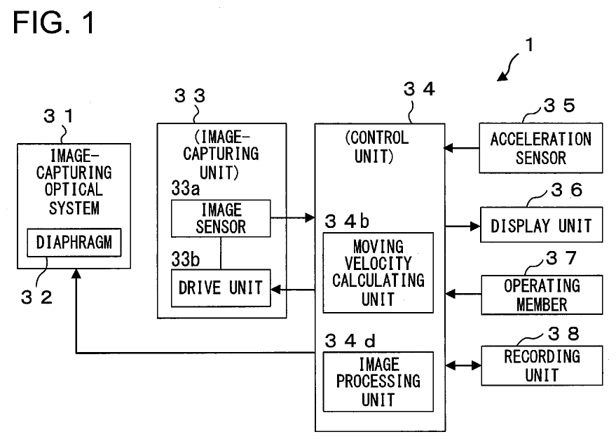

A first embodiment of an image-capturing device will be described with reference to FIGS. 1 to 6. FIG. 1 is a block diagram showing a configuration of a digital camera as an example of the image-capturing device according to the present embodiment. The camera 1 according to the present embodiment is a camera that generates moving images and still images by capturing images of subjects, with the camera attached to a moving person or object. That is, the camera 1 is a camera called an action camera, an action cam, a wearable camera, or the like. Further, the camera is not limited to a so-called action camera and the like, but may be a digital camera, a portable phone having a camera function, and the like. The camera 1 includes an image-capturing optical system 31, an image-capturing unit 33, a control unit 34, an acceleration sensor 35, a display unit 36, an operation member 37, and a recording unit 38.

The image-capturing optical system 31 guides a light flux from a subject field to the image-capturing unit 33. The image-capturing optical system 31 is provided with a diaphragm 32 in addition to lenses (not shown). The image-capturing unit 33 includes an image sensor 33a and a drive unit 33b. The image-capturing unit 33 photoelectrically converts a subject image formed by the image-capturing optical system 31 to generate an electric charge. The drive unit 33b generates a drive signal required for causing the image sensor 33a to perform exposure control, that is, electric charge accumulation control. Image-capturing instructions such as exposure time (accumulation time) to the image-capturing unit 33 are transmitted from the control unit 34 to the drive unit 33b.

The control unit 34 includes a CPU, for example, and controls overall operation of the camera 1. For example, the control unit 34 performs a predetermined exposure calculation based on a photoelectric conversion signal acquired by the image-capturing unit 33 to determine exposure conditions such as an exposure time of the image sensor 33a, an ISO sensitivity, an aperture value of the diaphragm 32 required for a proper exposure and instruct them to the drive unit 33b and the diaphragm 32.

The control unit 34 includes a moving velocity calculation unit 34b and an image processing unit 34d. The units are implemented in software by the control unit 34 executing program stored in a nonvolatile memory (not shown). Note that the units may include an ASIC and the like.

The moving velocity calculation unit 34b calculates a moving velocity of the camera 1 based on information on an acceleration of the camera 1. The image processing unit 34d performs image processing on the image data acquired by the image-capturing unit 33. In addition to compression processing described below, the image processing includes color interpolation processing, pixel defect correction processing, edge enhancement processing, noise reduction processing, white balance adjustment processing, gamma correction processing, display brightness adjustment processing, saturation adjustment processing, and the like. Further, the image processing unit 34d generates an image to be displayed by the display unit 36.

The acceleration sensor 35 detects the acceleration of the camera 1. The acceleration sensor 35 outputs the detected result to the moving velocity calculation unit 34b of the control unit 34. The moving velocity calculation unit 34b then calculates the moving velocity of the camera 1 based on the acceleration detected by the acceleration sensor 35.

The display unit 36 reproduces and displays images generated by the image processing unit 34d, images subjected to image processing, images read by the recording unit 38, and the like. The display unit 36 displays an operation menu screen, a setting screen for setting image-capturing conditions, and the like.

The operation member 37 includes various operation members such as a release button and a menu button. The operation member 37 sends operation signals corresponding to operations to the control unit 34. The operation member 37 includes a touch operation member provided on a display surface of the display unit 36.

In accordance with the instruction from the control unit 34, the recording unit 38 records image data and the like in a recording medium including a memory card (not shown) and the like. The recording unit 38 reads the image data recorded in the recording medium in accordance with the instruction from the control unit 34.

The camera 1 configured as described above can capture images of subjects to generate still images and moving images and record image data obtained by image-capturing in the recording medium.

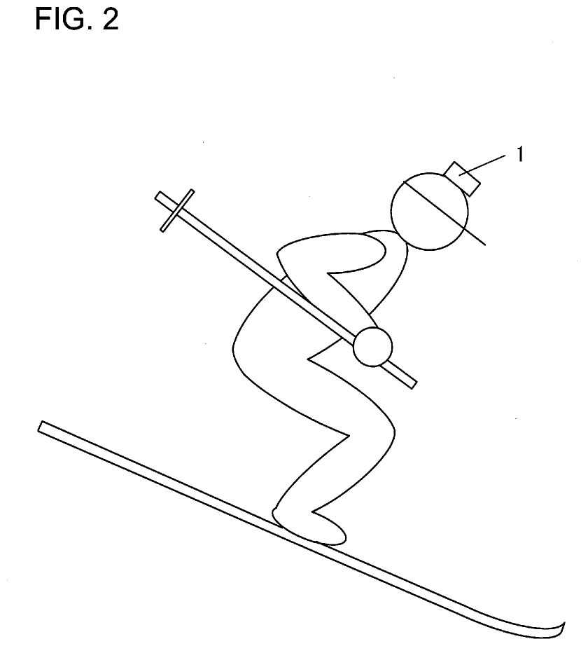

The camera 1 is suitable for being held by a moving person or object to capture images and generate moving images, as shown in FIG. 2. Here, the term “held” includes carried by a person and attached to a movable body such as a person or an object. FIG. 2 is a view schematically showing a camera 1 attached to the head of a skier (athlete). The skier who skis down a slope is an example of a moving person. In the example shown in FIG. 2, the camera 1 is attached to the head of the skier; however, the camera 1 may be attached to the chest or arm of the skier or may be attached to a ski plate.

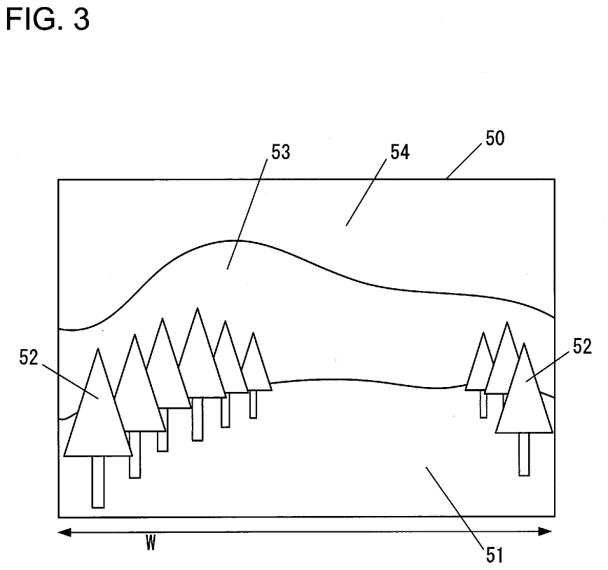

FIG. 3 is an example of an image in a frame of a moving image captured and generated by the camera 1 attached to the head of the skier shown in FIG. 2, showing a state of the slope. This image 50 includes a plurality of trees 52 located on both sides of a slope 51 covered with snow. The image 50 also includes a mountain 53 behind the slope 51, and a sky 54 above the mountain 53.

Generally, with this type of camera, photographing is performed with the photographing optical system 31 having a short focal length, that is, a wide angle of view. Additionally, photographing is often performed with a relatively short exposure time. When the camera 1 moves during image-capturing, the wide angle of view and the short exposure time may result in a reduced image blur of a surrounding scene, so that a viewer can experience less smoothness of a moving image during reproduction.

As a result, when the photographed and generated moving image is reproduced, a viewer experiences a sense of speed less than that actually experienced by the skier during photographing. For example, it is assumed that the camera 1 moves with a person as shown in FIG. 2. In this case, for example, a moving surrounding scene such as trees 52 in FIG. 3 is recorded in a moving image obtained by image-capturing with the camera 1. However, a viewer may experience less smoothness during reproduction, which may result in a reduced sense of speed.

In the following description, a subject that changes its position in the image-capturing range between frames, such as trees 52, may be referred to as a moving subject. That is, the term “moving” of a moving subject does not mean that the subject itself moves in reality, but means that the subject moves in a screen during reproduction of a moving image.

Thus, in the camera 1 according to the present embodiment, a generated moving image is compressed toward the center in the left-right direction, based on information on the movement of the camera. Here, the information on movement is velocity information during image-capturing of the camera 1. A generated moving image is compressed toward the center in the left-right direction, based on information on the movement of the camera 1. Here, the velocity information is information on the moving velocity of the camera 1, for example. A process of compressing a generated moving image toward the center in the left-right direction based on the velocity information of the camera 1 is referred to as compression processing. The compression processing is executed by the image processing unit 34d. Note that the information on movement may be any information with which the moving velocity of the camera 1 during image-capturing can be calculated; for example, information on a current position outputted by the GPS sensor and information on a distance between the camera 1 and a specific target.

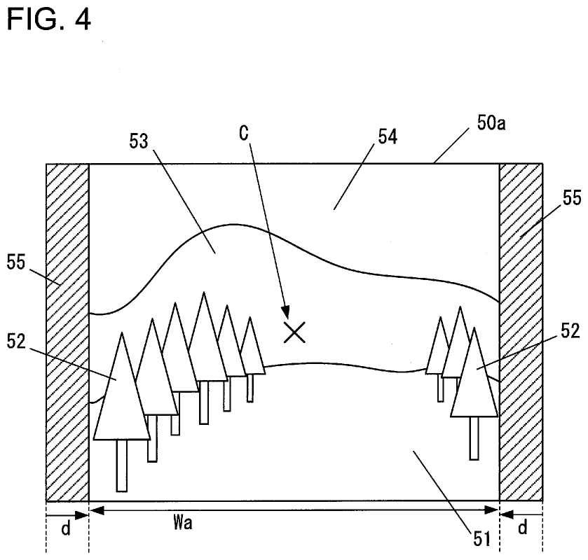

FIG. 4 is a view of explaining the compression processing. FIG. 4 illustrates an image 50a obtained by performing the compression processing on the image 50 illustrated in FIG. 3. The compression processing is processing for reducing a lateral width W of the image 50 to a shorter width Wa. The image processing unit 34d compresses the image 50 toward the center C in the left-right direction by a compression amount d. In other words, the image processing unit 34d laterally compresses the image 50. That is, the content of the image 50 is compressed in the image 50a by d×2 in the horizontal direction. It is desirable that frames of a moving image have a uniform width. That is, it is desirable that the width of the image 50 shown in FIG. 3 and the width of the image 50a shown in FIG. 4 match with each other. Then, the image processing unit 34d fills empty spaces 55 having a size of d×2 that are formed on right and left sides by reducing the width of the image, with a predetermined color (for example, black).

When the moving image is compressed toward the center C in the left-right direction, the trees 52 in the moving image approach the center C of the image as compared with a case where the moving image is not compressed. The sense of speed of the moving image is enhanced as a subject moving between frames, such as the trees 52, is closer to the center C. Thus, by compressing the image 50 shown in FIG. 3 into the image 50a shown in FIG. 4, the sense of speed of the moving image is enhanced. Note that the compression may be performed toward the center C in the up-down direction, instead of the left-right direction. In other words, the image processing unit 34d may compress the image 50 in the vertical direction.

The image processing unit 34d increases the compression amount d as the velocity indicated by the velocity information increases. In other words, the image processing unit 34d reduces the compression amount d as the velocity indicated by the velocity information decreases. For example, the image processing unit 34d sets a value obtained by multiplying the velocity indicated by the velocity information by a predetermined conversion coefficient, as the compression amount d. That is, the image processing unit 34d continuously sets the compression amount d based on the velocity information. Alternatively, the image processing unit 34d compares the velocity indicated by the velocity information with a predetermined threshold, and the image processing unit 34d adopts a predetermined compression amount d1 if the velocity is equal to or higher than the threshold, and adopts a compression amount d2 smaller than d1 if the velocity is less than the threshold. That is, the image processing unit 34d sets the compression amount d stepwise (discretely) based on the velocity information. The fact that the compression amount d is increased as the velocity indicated by the velocity information increases means that the sense of speed of the moving image to be generated is enhanced as the skier moves faster during image-capturing. In this way, the image processing unit 34d compresses the image 50 to enhance the sense of speed of the moving image to be reproduced. Thus, the sense of speed experienced by the viewer from the reproduced moving image can be brought closer to the sense of speed actually experienced by the skier.

Note that if it is desired to allow the viewer to always experience a sense of speed above a certain velocity during reproduction of a moving image, regardless of the velocity during image-capturing, the compression amount d may be reduced as the velocity indicated by the velocity information increases. In other words, the compression amount d may be increased as the velocity indicated by the velocity information decreases.

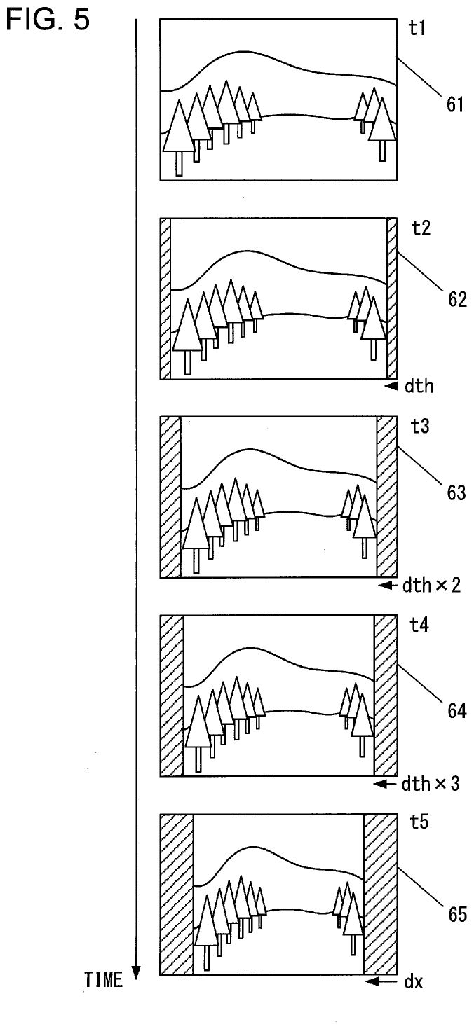

If the width of the subject suddenly changes between frames, the viewer may experience uncomfortable. Therefore, the image processing unit 34d limits a change amount of the compression amount d between frames. FIG. 5 is a view of explaining limitation of the change amount of the compression amount d. In FIG. 5, an image 61 captured at time t1, an image 62 captured at time t2 after time t1, an image captured at time t3 after time t2, an image 64 captured at time t4 after time t3, and an image 65 captured at time t5 after time t4 are shown, in order from top to bottom in the paper.

For example, it is assumed that the moving velocity calculation unit 34b calculates a moving velocity corresponding to a relatively large compression amount dx, at time t1. A compression amount at time t1 is zero. Therefore, in a case where the change amount of the compression amount is not limited, the compression amount is set to dx in the next frame. Now, it is assumed that a threshold value dth of the change amount of the compression amount is smaller than dx. In this case, the image processing unit 34d gradually increases the compression amount by dth until the compression amount reaches dx. For example, the compression amount in the image 62 captured at time t2 is dth. The compression amount in the image 63 captured at time t3 is dth×2. The compression amount in the image 64 captured at time t4 is dth×3. In the image 65 captured at time t5, the compression amount reaches dx.

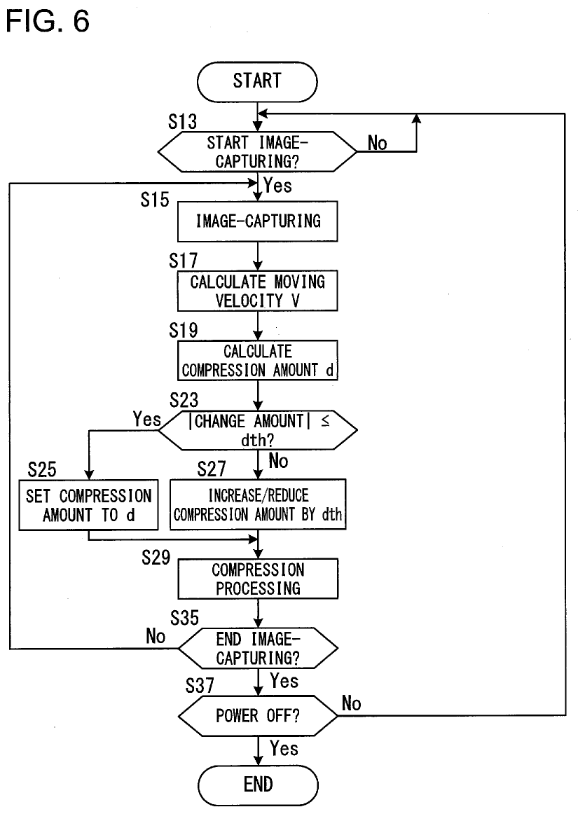

FIG. 6 is a flowchart showing a process relating to image-capturing of the camera 1 according to the first embodiment. The process of the flowchart shown in FIG. 6 is recorded in a memory (not shown) of the camera 1 or the like. When a power switch (not shown) of the camera 1 is turned on, the process shown in FIG. 6 is executed by the control unit 34. In step S13, the control unit 34 waits until the start of image-capturing is instructed by operation of a release button, for example. When the start of image-capturing is instructed, the control unit 34 starts photographing of a moving image. The process then proceeds to step S15.

In step S15, the control unit 34 controls the image-capturing unit 33 so as to capture an image of a subject. The process then proceeds to step S17. In step S17, the moving velocity calculation unit 34b calculates a moving velocity V of the camera 1 based on the information on the acceleration of the camera 1 detected by the acceleration sensor 35. The process then proceeds to step S19.

In step S19, the image processing unit 34d calculates a compression amount d from the moving velocity V of the camera 1. The process then proceeds to step S23. In step S23, the image processing unit 34d determines whether the absolute value of the change amount from the current compression amount to the compression amount d calculated in step S19 is equal to or less than the threshold value dth. If the determination result in step S23 is Yes, the process proceeds to step S25, where the image processing unit 34d sets the compression amount to the compression amount d calculated in step S19. The process then proceeds to step S29.

If the absolute value of the change amount from the current compression amount to the compression amount d calculated in step S19 exceeds the threshold value dth, the determination result in step S23 is No. The process then proceeds to step S27. In step S27, the image processing unit 34d brings the compression amount closer to the compression amount d calculated in step S19 by dth. The process then proceeds to step S29. That is, the image processing unit 34d increases or decreases the compression amount by dth, and the process proceeds to step S29.

In step S29, the image processing unit 34d executes compression processing using the compression amount set in step S25 or step S27. The process then proceeds to step S35.

In step S35, the control unit 34 determines whether an end of image-capturing of the moving image has been instructed. If the determination result in step S35 is No, the process returns to step S15. If the determination result in step S35 is Yes, the process proceeds to step S37.

In step S37, the control unit 34 determines whether a power switch (not shown) is turned off. If the determination result in step S37 is No, the process returns to step S13. If the determination result in step S37 is Yes, the program ends.

The camera 1 according to the first embodiment has the following operational advantages.

(1) The image processing unit 34d laterally compresses the image 50 constituting the moving image based on the velocity information on the movement of the camera 1, to generate a moving image to be displayed on the display unit. As a result, a moving image providing a desired sense of speed can be obtained.

(2) When the moving velocity of the camera 1 based on the velocity information represents a second velocity higher than a first velocity, the image processing unit 34d compresses the image with a second compression amount larger than a first compression amount to generate a moving image. That is, the image processing unit 34d performs compression to enhance the sense of speed of the moving image to be reproduced. As a result, it is possible to allow the viewer who watches a moving image captured during movement at high speed to experience an enhanced sense of speed.

(3) When the moving velocity of the camera 1 based on the velocity information represents a fourth velocity lower than a third velocity, the image processing unit 34d compresses the image with a fourth compression amount smaller than a third compression amount to generate a moving image. As a result, it is possible to allow the viewer who watches a moving image captured during movement at low speed to experience a reduced sense of speed.

### Second Embodiment

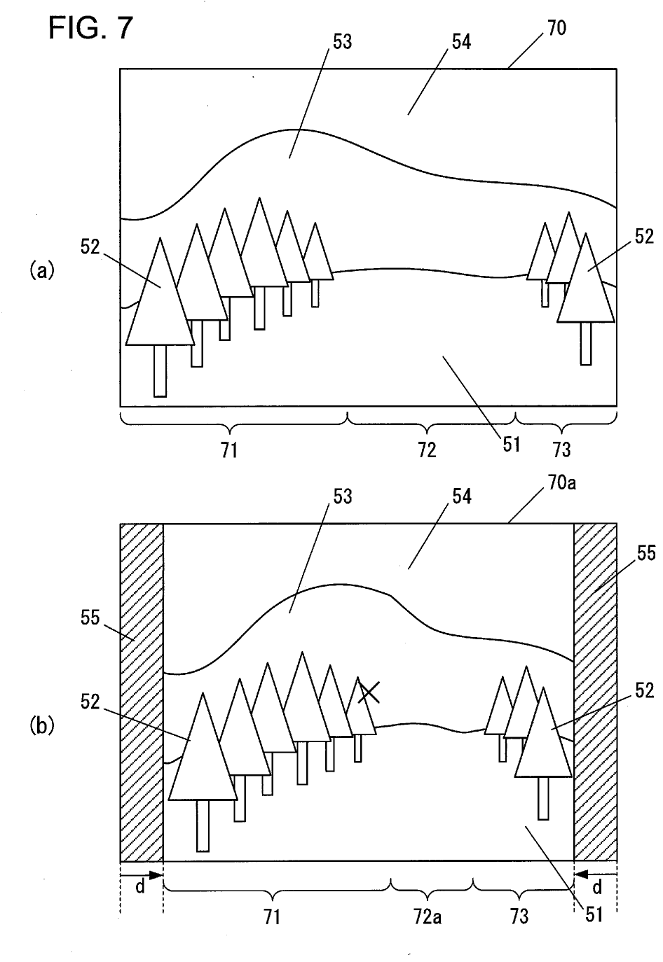

A second embodiment of an image-capturing device will be described with reference to FIG. 7. In the following description, the same components as those in the first embodiment are designated by the same reference numerals, and differences will mainly be described. Features not specifically described are the same as in the first embodiment.

In the second embodiment, the image processing unit 34d executes compression processing having properties different from the properties described in the first embodiment. The compression processing in the first embodiment is a process of compressing an image toward the center in the left-right direction, as described in FIG. 4. As a result, for example, the trees 52 shown in FIG. 4 are distorted to be elongated in the vertical direction. In the compression processing in the second embodiment, the image is compressed toward the center from the left-right direction while maintaining a shape of a moving subject, such as the trees 52. Note that the calculation of the compression amount d from the moving velocity V is the same as that in the first embodiment.

FIG. 7 is a view of explaining the compression processing. FIG. 7(a) shows an image 70 of a plurality of images constituting a moving image. FIG. 7(a) shows an image 70 before compression, which is a target of compression processing, and FIG. 7(b) shows an image 70a obtained by compressing the image 70. The image processing unit 34d recognizes and detects that the trees 52 are moving subjects in the image 70 by a known technique. For example, the image processing unit 34d calculates a difference between frames, and recognizes and detects a subject in a portion where the difference is equal to or larger than a predetermined value, as a moving subject. Here, the moving subject is a subject that moves relative to the camera 1 as a result of movement of the moving body holding the camera 1.

Note that the moving subject may be considered as a subject near the camera 1. This is because a position of a subject located far from the camera 1 hardly changes in the image between frames even when the camera 1 moves. That is, since a subject near the camera 1 moves largely between the frames as the camera 1 moves, the subject near the camera 1 may be considered as a subject moving between frames.

For example, the image processing unit 34d detects a distance from the camera 1 to the subject using a known TOF (Time of Flight) sensor, and recognizes and detects the subject existing within a certain distance from the camera 1 as a moving subject. The TOF sensor is an image sensor used for a known TOF method. The TOF method involves a technique of emitting a light pulse (irradiation light) from a light source unit (not shown) toward a subject and detecting a distance to the subject based on a time until the light pulse reflected from the subject returns to a TOF sensor.

In the compression processing, the image processing unit 34d does not compress a region 71 and a region 73 where the trees 52 exist, and compresses only a region 72 where the trees 52 do not exist. In a compressed image 70a, the trees 52 maintain their shape before compression as they are. On the other hand, a subject in the region 72a obtained by compressing the region 72 has a largely distorted shape compared with that in the first embodiment. However, unlike the trees 52, the subject does not move between frames. Thus, unnaturalness due to distortion is relatively small.

Note that the compression processing may be executed using a known technique such as seam carving. Seam carving is a technique that changes the size of an image by recognizing individual subjects in the image and deforming unimportant subjects such as a background while maintaining the shape of important subjects.

The camera 1 according to the second embodiment has the following operational advantages, in addition to the operational advantages of the camera 1 according to the first embodiment.

(1) The image processing unit 34d generates a moving image based on the recognition result of a subject. Thereby, an optimal moving image may be generated for each subject. Specifically, the image processing unit 34d recognizes a moving object that moves relative to the camera 1 as a result of movement of the camera 1. Based on the recognition result, which is the position of the moving object, the image processing unit 34d determines which region of the image constituting the moving image is to be compressed. Thereby, the sense of speed of the moving image can be enhanced while maintaining the shape of the important subject.

### Third Embodiment

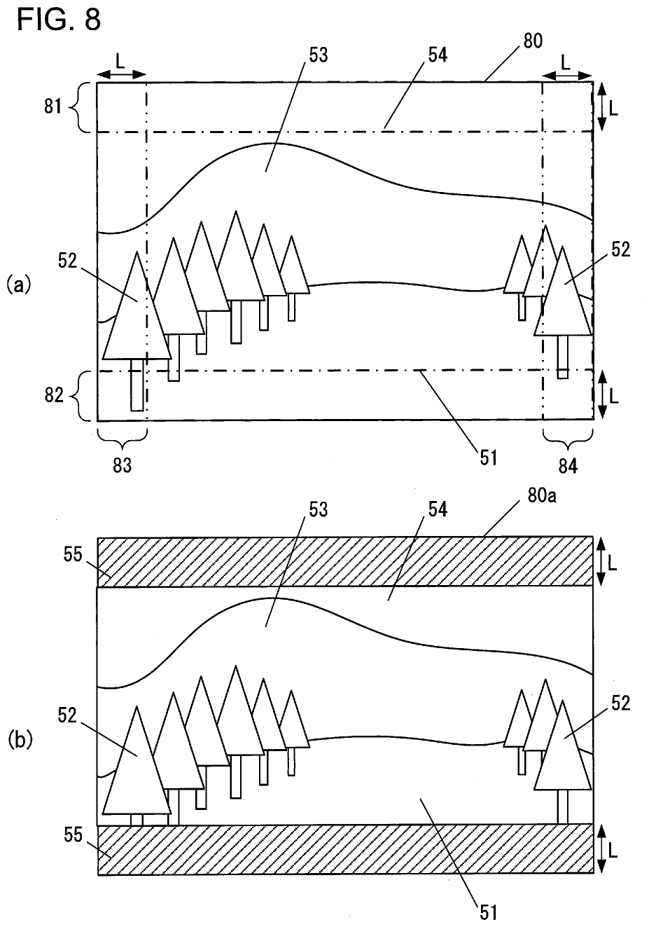

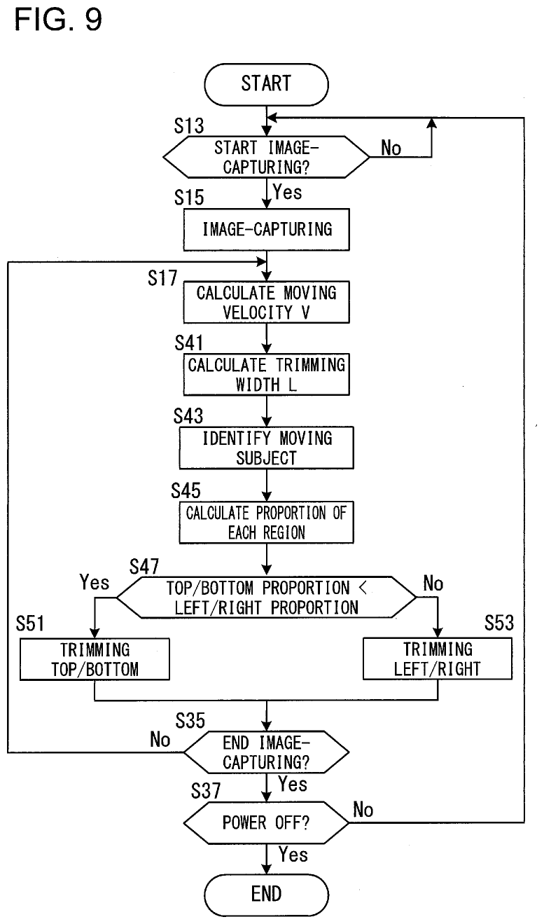

A third embodiment of an image-capturing device will be described with reference to FIGS. 8 and 9. In the following description, the same components as those in the first embodiment are designated by the same reference numerals, and differences will mainly be described. Features not specifically described are the same as in the first embodiment.

In the third embodiment, the image processing unit 34d executes trimming processing, instead of the compression processing described in the first embodiment. The trimming processing cuts out a part of an image. Specifically, the trimming processing removes upper and lower regions or left and right regions of the image. In other words, the trimming processing changes an image-capturing region of the image sensor 33a. By narrowing the field of view of the image by the trimming processing, the sense of immersion in the moving image is enhanced, and the sense of speed of the moving image is enhanced.

FIG. 8 is a view for explaining the trimming processing. FIG. 8(a) shows an image 80 before trimming, which is a target of trimming processing, and FIG. 8(b) shows an image 80a obtained by trimming the image 80. The image processing unit 34d calculates a trimming width L based on a moving velocity V. The image processing unit 34d calculates the trimming width L in the same manner as the compression amount d in the first embodiment. That is, the image processing unit 34d increases the trimming width L (makes the image-capturing region narrower) as the moving velocity V increases. In other words, the image processing unit 34d reduces the trimming width L (makes the image-capturing region wider) as the moving velocity V decreases. Thus, the sense of speed experienced by the viewer from the reproduced moving image can be brought closer to the sense of speed actually experienced by the skier.

Note that if it is desired to allow the viewer to always experience a sense of speed above a certain level during reproduction of a moving image, regardless of the velocity during image-capturing, the trimming width L may be increased (the image-capturing region may be reduced) as the moving velocity V decreases. In other words, the trimming width L may be reduced (the image-capturing region may be increased) as the moving velocity V increases.

The image processing unit 34d recognizes and detects that the trees 52 are moving subjects in the image 80 by a known technique, as in the second embodiment. For example, the image processing unit 34d calculates a difference between frames, and detects a subject in a portion where the difference is equal to or larger than a predetermined value, as a moving subject. Note that the moving subject may be considered as a subject near the camera 1, as described in the second embodiment.

The image processing unit 34d sets a region 81 having a length of the trimming width L downward from the upper end of the image 80 and a region 82 having a length of the trimming width L upward from the lower end of the image 80. The image processing unit 34d calculates a proportion occupied by the trees 52 which are moving subjects in the region 81 and the region 82. In FIG. 8(a), since the trees 52 are hardly included in the regions 81 and 82, this proportion is extremely small.

The image processing unit 34d sets a region 83 having a length of the trimming width L to the right from the left end of the image 80 and a region 84 having a length of the trimming width L to the left from the right end of the image 80. The image processing unit 34d calculates a proportion occupied by the trees 52 which are moving subjects in the region 83 and the region 84. In FIG. 8(a), this proportion is larger than the proportion calculated in the regions 81 and 82.

The image processing unit 34d compares the proportion of trees 52 in the regions 81 and 82 with the proportion of trees 52 in the regions 83 and 84. The image processing unit 34d trims (cuts out and removes) the regions 81 and 82, which have the smaller proportion, to generate an image 80a shown in FIG. 8(b).

Note that, instead of the proportion occupied by the trees 52, the amounts of textures in individual regions may be compared. For example, in a region largely occupied by subjects having a small amount of textures, such as sky 54, the trimming hardly affects the sense of speed. Thus, by trimming regions having the smaller amount of texture, the sense of speed can be enhanced without loss of the information amount of the image. In addition to comparing the amounts of textures as described above, the amount of high frequency components may be compared.

As in the first embodiment, it is desirable that frames of a moving image have a uniform width. Then, the image processing unit 34d fills empty spaces 55 having a size of L×2 that are formed on upper and lower sides by trimming, with a predetermined color (for example, black).

Note that the change amount of the trimming width L between frames may be limited, as in the case of the compression amount din the first embodiment. That is, the trimming width may be gradually changed so that the size of the free space 55 does not rapidly change between frames.

Additionally, if vertical trimming and horizontal trimming frequently change between frames, the viewer may experience uncomfortable. Thus, when vertical trimming is executed in a certain frame, only vertical trimming may be thereafter executed for a certain period without performing horizontal trimming. The period may be a predetermined period (for example, 1 second or 30 frames) or a period until the trimming width L becomes equal to or less than a predetermined amount (for example, zero).

FIG. 9 is a flowchart showing a process relating to image-capturing of the camera 1 according to the third embodiment. The process of the flowchart shown in FIG. 9 is recorded in a memory (not shown) of the camera 1 or the like. When a power switch (not shown) of the camera 1 is turned on, the process shown in FIG. 9 is executed by the control unit 34. In step S13, the control unit 34 waits until the start of image-capturing is instructed by operation of a release button, for example. When the start of image-capturing is instructed, the control unit 34 starts photographing of a moving image. The process then proceeds to step S15.

In step S15, the control unit 34 controls the image-capturing unit 33 so as to capture an image of a subject. The process then proceeds to step S17. In step S17, the moving velocity calculation unit 34b calculates a moving velocity V of the camera 1 based on the information on the acceleration of the camera 1 detected by the acceleration sensor 35. The process then proceeds to step S41.

In step S41, the image processing unit 34d calculates a trimming width L from the moving velocity V of the camera 1. The process then proceeds to step S43. In step S43, the image processing unit 34d identifies a moving subject from the image. The process then proceeds to step S45. In step S45, the image processing unit 34d calculates a proportion of moving subjects in upper and lower regions and a proportion of moving subjects in left and right regions. The process then proceeds to step S47. In step S47, the image processing unit 34d determines whether the proportion in the upper and lower regions is less than the proportion in the left and right regions. If the determination result in step S47 is Yes, the process proceeds to step S51, where the image processing unit 34d performs trimming of upper and lower regions. The process then proceeds to step S35.

If the vertical proportion is equal to or greater than the horizontal proportion, the determination result in step S47 is No. The process then proceeds to step S53. In step S53, the image processing unit 34d trims the left and right regions. The process then proceeds to step S35.

In step S35, the control unit 34 determines whether an end of image-capturing of the moving image has been instructed. If the determination result in step S35 is No, the process returns to step S15. If the determination result in step S35 is Yes, the process proceeds to step S37.

In step S37, the control unit 34 determines whether a power switch (not shown) is turned off. If the determination result in step S37 is No, the process returns to step S13. If the determination result in step S37 is Yes, the program ends.

The camera 1 according to the third embodiment has the following operational advantages.

(1) The image processing unit 34d changes the image-capturing region of the image sensor 33a generating a moving image, based on velocity information on a movement of the camera 1. As a result, a moving image having a desired sense of speed can be obtained.

(2) When the moving velocity of the camera 1 based on the velocity information represents a second velocity higher than a first velocity, the image processing unit 34d generates a moving image of a second image-capturing region smaller than a first image-capturing region. In this way, the image processing unit 34d generates a moving image of a small image-capturing region as the moving velocity of the camera 1 based on the velocity information increases. That is, the image processing unit 34d varies the image-capturing regions in order to enhance the sense of speed of the moving image to be reproduced. As a result, it is possible to allow the viewer who watches a moving image captured during movement at high speed to experience an enhanced sense of speed.

(3) When the moving velocity of the camera 1 based on the velocity information represents a fourth velocity lower than a third velocity, the image processing unit 34d generates a moving image of a fourth image-capturing region larger than a third image-capturing region. Thus, the image processing unit 34d generates a moving image of a larger image-capturing region as the moving velocity of the camera 1 based on the velocity information decreases. As a result, it is possible to allow the viewer who watches a moving image captured during movement at low speed to experience a reduced sense of speed.

### Fourth Embodiment

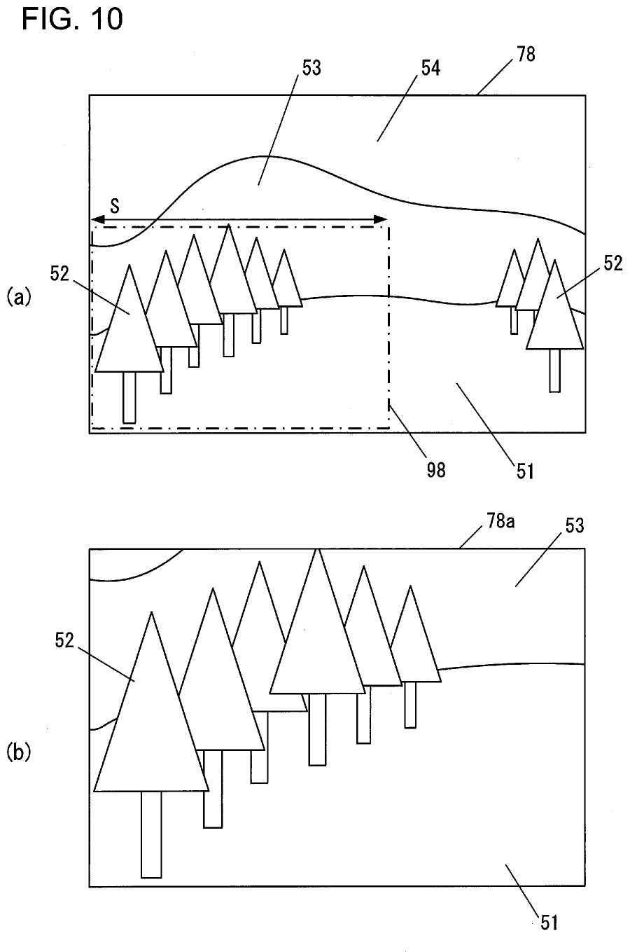

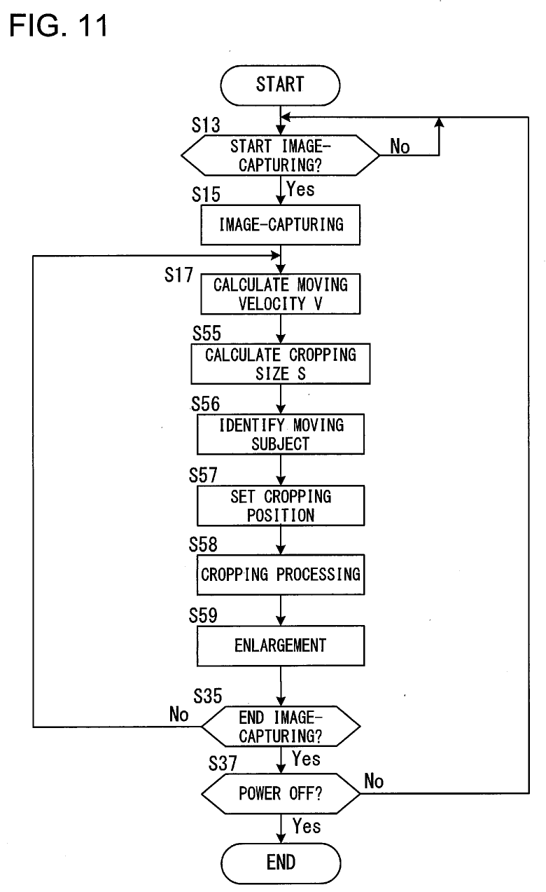

A fourth embodiment of an image-capturing device will be described with reference to FIGS. 10 and 11. In the following description, the same components as those in the third embodiment are designated by the same reference numerals, and differences will mainly be described. Features not specifically described are the same as in the third embodiment.

In the fourth embodiment, the image processing unit 34d executes cropping processing, instead of the trimming processing described in the third embodiment. The cropping processing cuts out a partial region of an image and removes other region.

FIG. 10 is a view of explaining cropping processing. FIG. 10(a) shows an image 78 before cropping, which is a target of the cropping processing, and FIG. 10(b) shows an image 78a obtained by cropping the image 78. The image processing unit 34d calculates a cropping size S based on a moving velocity V. The image processing unit 34d reduces a cropping size S as the moving velocity V increases. In other words, the image processing unit 34d increases the cropping size S as the moving velocity V decreases. Thus, the sense of speed experienced by the viewer from the reproduced moving image can be brought closer to the sense of speed actually experienced by the skier.

Note that if it is desired to allow the viewer to always experience a sense of speed above a certain level during reproduction of a moving image, regardless of the velocity during image-capturing, the cropping size S may be reduced as the moving velocity V decreases. In other words, the cropping size S may be increased as the moving velocity V increases.

As in the second embodiment, the image processing unit 34d detects that the trees 52 are moving subjects in the image 78, by a known technique. For example, the image processing unit 34d calculates a difference between frames, and detects a subject in a portion where the difference is equal to or larger than a predetermined value, as a moving subject. Note that the moving subject may be considered as a subject near the camera 1, as described in the second embodiment.

The image processing unit 34d sets a rectangular region 98 in the image 78, the rectangular region 98 having the same aspect ratio as the image 78 and having long sides of the cropping size S. The image processing unit 34d sets the position of the region 98 such that the proportion occupied by the trees 52, which are the moving subjects, in the region 98 is as high as possible. For example, in FIG. 10(a), the position of the region 98 is set to a position where as many trees 52 as possible are included in the region 98.

The image processing unit 34d cuts out a partial image in a range occupied by the region 98 from the image 78 and generates an image 78a that is enlarged to the same size as the image 78. An example of the image 78a is shown in FIG. 10(b). Note that, instead of enlarging to the same size as that of the image 78, empty spaces 55 formed on top, bottom, left, and right sides of the cutout partial image may be filled with a predetermined color (for example, black).

The proportion of the trees 52, which are moving subjects, in the entire image 78a is larger than the proportion of the trees 52, which are moving subjects, in the entire image 78 before cropping. Therefore, the sense of speed of the moving image enhances.

Note that the change amount of the cropping size S between frames may be limited, as in the case of the compression amount d in the first embodiment. That is, the cropping size may be gradually changed so that the size of the region 98 does not rapidly change between frames.

Additionally, if the cropping position frequently changes between frames, the viewer may experience uncomfortable. Thus, when the cropping processing is executed on a certain frame, the cropping position may remain unchanged for a certain period thereafter. Alternatively, the change amount of the cropping position may be limited. That is, the cropping position may be gradually changed so that the cropping position does not rapidly change between frames.

FIG. 11 is a flowchart showing a process relating to image-capturing of the camera 1 according to the fourth embodiment. The process of the flowchart shown in FIG. 11 is recorded in a memory (not shown) of the camera 1 or the like. When a power switch (not shown) of the camera 1 is turned on, the process shown in FIG. 11 is executed by the control unit 34. In step S13, the control unit 34 waits until the start of image-capturing is instructed by operation of a release button, for example. When the start of image-capturing is instructed, the control unit 34 starts photographing of a moving image. The process then proceeds to step S15.

In step S15, the control unit 34 controls the image-capturing unit 33 so as to capture an image of a subject. The process then proceeds to step S17. In step S17, the moving velocity calculation unit 34b calculates a moving velocity V of the camera 1 based on the information on the acceleration of the camera 1 detected by the acceleration sensor 35. The process then proceeds to step S55.

In step S55, the image processing unit 34d calculates a cropping size S from the moving velocity V of the camera 1. The process then proceeds to step S56. In step S56, the image processing unit 34d identifies a moving subject from the image. The process then proceeds to step S57. In step S57, the image processing unit 34d sets the cropping position so that the moving subject is included as large as possible. The process then proceeds to step S58. In step S58, the image processing unit 34d performs cropping processing, that is, cuts out a partial image. The process then proceeds to step S59. In step S59, the image processing unit 34d enlarges the partial image cut out in step S58 to an image size before the cropping processing. The process then proceeds to step S35.

In step S35, the control unit 34 determines whether the end of image-capturing of the moving image has been instructed. If the determination result in step S35 is No, the process returns to step S15. If the determination result in step S35 is Yes, the process proceeds to step S37.

In step S37, the control unit 34 determines whether a power switch (not shown) is turned off. If the determination result in step S37 is No, the process returns to step S13. If the determination result in step S37 is Yes, the program ends.

The camera 1 of the fourth embodiment can achieve the same operational advantages as those of the third embodiment.

### Fifth Embodiment

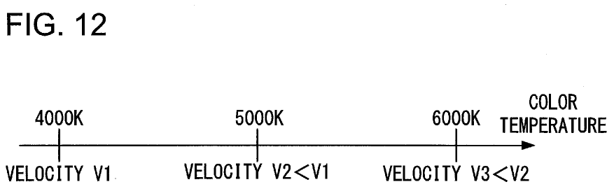

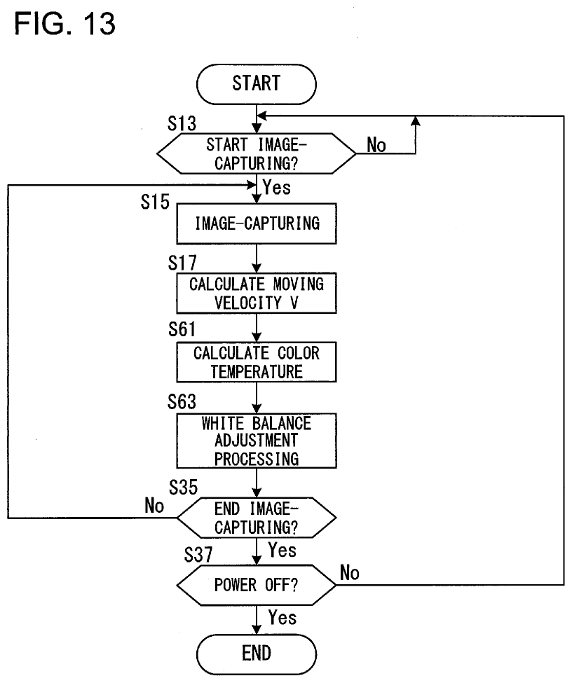

A fifth embodiment of an image-capturing device will be described with reference to FIGS. 12 and 13. In the following description, the same components as those in the first embodiment are designated by the same reference numerals, and differences will mainly be described. Features not specifically described are the same as in the first embodiment.

In the fifth embodiment, the image processing unit 34d executes white balance adjustment processing, instead of the compression processing described in the first embodiment. White balance adjustment processing adjusts the color temperature of an image. When the color temperature of the image is changed by the white balance adjustment processing, the proportion of an advancing color and a receding color in the entire image is changed, and the sense of speed of the moving image is increased or decreased. That is, the image processing unit 34d adjusts the sense of speed of the moving image by adjusting the proportion of the predetermined color in the moving image.

Note that the term “advancing color” refers to warm colors, colors having high brightness, colors having high saturation, and the like. For example, warm colors include red, pink, yellow, and orange. Similarly, the term “receding color” refers to cold colors, colors having low brightness, colors having low saturation, and the like. For example, the cold colors include blue, white, black, and gray. A subject having strong advancing colors provides more higher sense of speed. A subject having strong receding colors provides more lower sense of speed.

FIG. 12 is a view of explaining the white balance adjustment processing. For example, when the moving velocity of the camera 1 is V1, the image processing unit 34d sets the color temperature to 4000 K (kelvin). When the moving velocity of the camera 1 is V2 which is lower than V1, the image processing unit 34d sets the color temperature to 5000 K. When the moving velocity of the camera 1 is V3 which is lower than V2, the image processing unit 34d sets the color temperature to 6000 K.

Note that the color temperature may be set continuously based on the moving velocity V or may be set stepwise (discretely). Further, the numerical values of the color temperature shown in FIG. 12 are merely examples, and it is of course that different numerical values may be employed.

As described above, the image processing unit 34d increases the color temperature as the moving velocity V decreases. As the color temperature is increased, blue becomes stronger and red becomes weaker in the image, so that the image becomes bluish. That is, the advancing colors are diminished and the receding colors are intensified. That is, the image processing unit 34d increases (rises) the proportion of cold colors, as the moving velocity V decreases. As a result, the sense of speed of the moving image decreases.

Further, the image processing unit 34d lowers the color temperature as the moving velocity V of the camera 1 increases. As the color temperature is reduced, red becomes stronger and blue becomes weaker in the image, so that the image becomes reddish or yellowish. That is, the advancing colors are intensified and the receding colors are diminished. That is, the image processing unit 34d increases (rises) the proportion of warm colors as the moving velocity V increases. As a result, the sense of speed of the moving image is enhanced.

Thus, the sense of speed experienced by the viewer from the reproduced moving image can be brought closer to the sense of speed actually experienced by the skier.

Note that if it is desired to allow the viewer to always experience a sense of speed above a certain velocity during reproduction of a moving image, regardless of the velocity during image-capturing, the color temperature may be increased as the moving velocity V increases. In other words, the color temperature may be lowered as the moving velocity V decreases.

FIG. 13 is a flowchart showing a process relating to image-capturing of the camera 1 according to the fifth embodiment. The process of the flowchart shown in FIG. 13 is recorded in a memory (not shown) of the camera 1 or the like. When a power switch (not shown) of the camera 1 is turned on, the process shown in FIG. 13 is executed by the control unit 34. In step S13, the control unit 34 waits until the start of image-capturing is instructed by operation of a release button, for example. When the start of image-capturing is instructed, the control unit 34 starts photographing of a moving image. The process then proceeds to step S15.

In step S15, the control unit 34 controls the image-capturing unit 33 so as to capture an image of a subject. The process then proceeds to step S17. In step S17, the moving velocity calculation unit 34b calculates a moving velocity V of the camera 1 based on the information on the acceleration of the camera 1 detected by the acceleration sensor 35. The process then proceeds to step S61.

In step S61, the image processing unit 34d calculates a color temperature from the moving velocity V of the camera 1. The process then proceeds to step S63. In step S63, the image processing unit 34d performs white balance adjustment of the color temperature calculated in step S61. The process then proceeds to step S35.

In step S35, the control unit 34 determines whether an end of image-capturing of the moving image has been instructed. If the determination result in step S35 is No, the process returns to step S15. If the determination result in step S35 is Yes, the process proceeds to step S37.

In step S37, the control unit 34 determines whether a power switch (not shown) is turned off. If the determination result in step S37 is No, the process returns to step S13. If the determination result in step S37 is Yes, the program ends.

The camera 1 according to the fifth embodiment has the following operational advantages.

(1) The image processing unit 34d controls the color information of the image-capturing signal to generate an image, based on the velocity information, which is information on the movement of the camera 1. As a result, a moving image having a desired sense of speed can be obtained.

(2) The image processing unit 34d adjusts the proportion of a predetermined color based on the velocity information. In this way, the sense of speed experienced from a moving image can be adjusted only by simple image processing.

(3) The image processing unit 34d adjusts the proportion of a predetermined color according to the color temperature set based on the velocity information. In this way, the sense of speed experienced from a moving image can be adjusted only by executing the known white balance processing.

(4) When the moving velocity of the camera 1 becomes a second moving velocity higher than a first moving velocity, the image processing unit 34d increases the proportion of warm colors. On the other hand, when the moving velocity of the camera 1 becomes a fourth moving velocity lower than a third moving velocity, the image processing unit 34d increases the proportion of cold colors. That is, the image processing unit 34d increases the proportion of warm colors as the moving velocity of the camera 1 increases, and increases the proportion of cold colors as the moving velocity of the camera 1 decreases. In this way, the image processing unit 34d adjusts the proportion of the predetermined color to enhance the sense of speed of the moving image to be reproduced. Thereby, the viewer of the moving image can also experience the sense of speed experienced by the person holding the camera 1.

### Sixth Embodiment

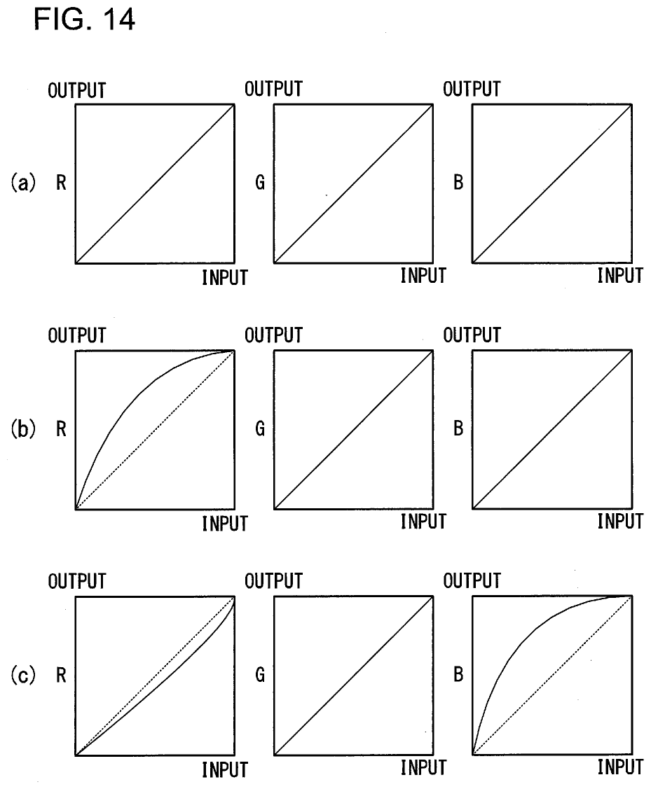

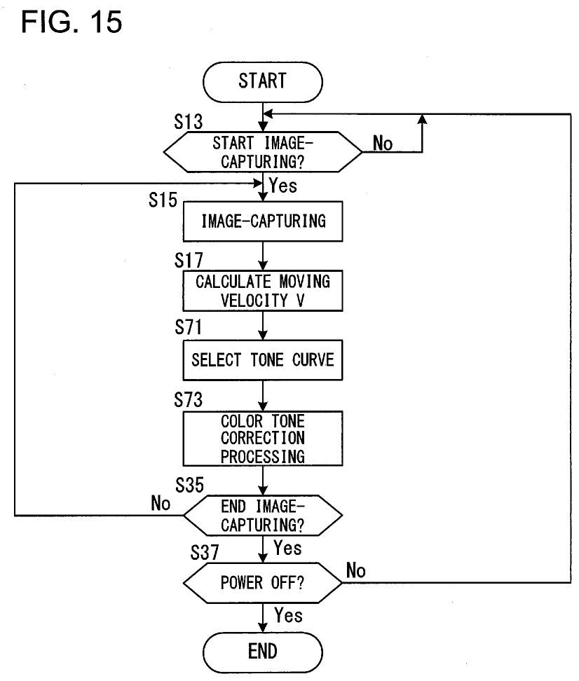

A sixth embodiment of an image-capturing device will be described with reference to FIGS. 14 and 15. In the following description, the same components as those in the fifth embodiment are designated by the same reference numerals, and differences will mainly be described. Features not specifically described are the same as in the fifth embodiment.

In the sixth embodiment, the image processing unit 34d executes color tone correction processing, instead of the white balance adjustment processing. The color tone correction processing adjusts a color tone of an image for each of red, green, and blue components. That is, the image processing unit 34d according to the sixth embodiment adjusts the color tone of the image, instead of adjusting the white balance (color temperature) of the image. When the intensity of red component and blue component of the image is changed by the color tone correction, the proportion of advancing colors and receding colors in the entire image is changed, and the sense of speed of the moving image is increased or decreased. That is, the image processing unit 34d adjusts the sense of speed of the moving image by adjusting the proportion of the predetermined color in the moving image.

FIG. 14 is a view of explaining color tone correction processing. When the moving velocity of the camera 1 is V1, the image processing unit 34d performs a color tone correction in accordance with a tone curve shown in FIG. 14(a). In FIG. 14(a), R indicates a tone curve of the red component, G indicates a tone curve of the green component, and B indicates a tone curve of the blue component. The tone curve is a curve indicating input/output characteristics, with the horizontal axis as an input value and the vertical axis as an output value. As shown in FIG. 14(a), when the moving velocity of the camera 1 is V1, the tone curve of each color has an input value and an output value in a 1:1 relationship. That is, the color tone of the image remains unchanged.

When the moving velocity of the camera 1 is V2 which is higher than V1, the image processing unit 34d performs a color tone correction in accordance with a tone curve shown in FIG. 14(b). In the tone curve shown in FIG. 14(b), the output value of the red component is intensified relative to the input value. That is, when the color tone correction is performed in accordance with the tone curve shown in FIG. 14(b), the image becomes more reddish and the proportion of advancing colors increases. Therefore, the sense of speed of the moving image is enhanced. That is, the image processing unit 34d increases (rises) the proportion of warm colors as the moving velocity V increases.

When the moving velocity of the camera 1 is V3 that is lower than V1, the image processing unit 34d performs color a tone correction according to the tone curve shown in FIG. 14(c). In the tone curve shown in FIG. 14(c), the output value of the red component is diminished relative to the input value, and the output value of the blue component is intensified relative to the input value. That is, when the color tone correction is performed in accordance with the tone curve shown in FIG. 14(c), the image becomes less reddish and the proportion of advancing colors decreases, while the image becomes more bluish and the proportion of receding colors increases. Therefore, the sense of speed of the moving image is attenuated. That is, the image processing unit 34d increases (rises) the proportion of cold colors, as the moving velocity V decreases.

Note that the color tone correction may be set continuously based on the moving velocity V or may be set stepwise (discretely).

As described above, as the moving velocity V of the camera 1 decreases, the image processing unit 34d reduces the proportion of advancing colors in the entire image and increases the proportion of receding colors in the entire image. In other words, as the moving velocity V of the camera 1 increases, the image processing unit 34d increases the proportion of advancing colors in the entire image and reduces the proportion of receding colors in the entire image. Thus, the sense of speed experienced by the viewer from the reproduced moving image can be brought closer to the sense of speed actually experienced by the skier.

Note that if it is desired to allow the viewer to always experience a sense of speed above a certain velocity during reproduction of a moving image, regardless of the velocity during image-capturing, the proportion of advancing colors in the entire image may be reduced and the proportion of receding colors in the entire image may be increased as the moving velocity V increases. In other words, as the moving velocity V decreases, the proportion of advancing colors in the entire image may be increased and the proportion of receding colors in the entire image may be reduced.

Note that a process of replacing a predetermined color may be executed, instead of the color tone correction processing. For example, the sense of speed of the moving image may be adjusted by replacing a predetermined red color with a more bluish color or vice versa to change the proportion of advancing colors and receding colors.

Also, an advancing color to be intensified (diminished) may be switched depending on the type of a subject. For example, when a person is present as a subject, it is desirable to intensify orange color rather than red color because intensified red color may cause unnaturalness when viewed.

FIG. 15 is a flowchart showing a process relating to image-capturing of the camera 1 according to the sixth embodiment. The process of the flowchart shown in FIG. 15 is recorded in a memory (not shown) of the camera 1 or the like. When a power switch (not shown) of the camera 1 is turned on, the process shown in FIG. 15 is executed by the control unit 34. In step S13, the control unit 34 waits until the start of image-capturing is instructed by operation of a release button, for example. When the start of image-capturing is instructed, the control unit 34 starts photographing of a moving image. The process then proceeds to step S15.

In step S15, the control unit 34 controls the image-capturing unit 33 so as to capture an image of a subject. The process then proceeds to step S17. In step S17, the moving velocity calculation unit 34b calculates a moving velocity V of the camera 1 based on the information on the acceleration of the camera 1 detected by the acceleration sensor 35. The process then proceeds to step S71.

In step S71, the image processing unit 34d selects a tone curve from the moving velocity V of the camera 1. The process then proceeds to step S73. The tone curve for each moving velocity V is stored in a non-volatile memory (not shown) provided in the camera 1, for example. The image processing unit 34d selects a tone curve corresponding to the moving velocity V and reads it from the non-volatile memory. In step S73, the image processing unit 34d adjusts the color tone of the image using the tone curve selected in step S71. The process then proceeds to step S35.

In step S35, the control unit 34 determines whether an end of image-capturing of the moving image has been instructed. If the determination result in step S35 is No, the process returns to step S15. If the determination result in step S35 is Yes, the process proceeds to step S37.

In step S37, the control unit 34 determines whether a power switch (not shown) is turned off. If the determination result in step S37 is No, the process returns to step S13. If the determination result in step S37 is Yes, the program ends.

The camera 1 of the sixth embodiment can achieve the same operational advantages as those of the fifth embodiment.

### Seventh Embodiment

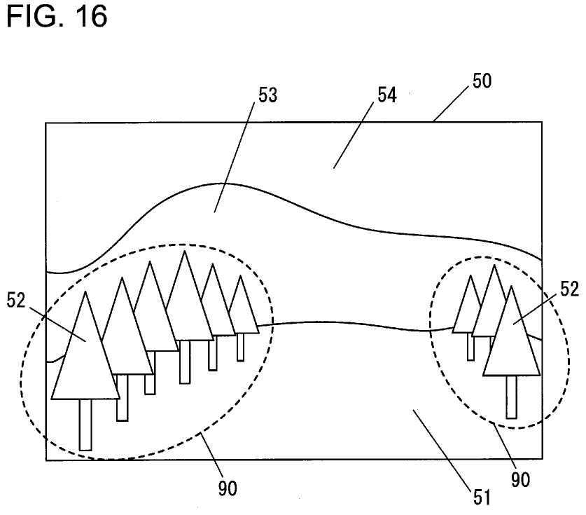

A seventh embodiment of an image-capturing device will be described with reference to FIG. 16. In the following description, the same components as those in the sixth embodiment are designated by the same reference numerals, and differences will mainly be described. Features not specifically described are the same as in the sixth embodiment.

In the seventh embodiment, the image processing unit 34d executes color tone correction processing on a moving subject, instead of executing color tone correction processing on the entire image. When the intensity of red component and blue component of the moving subject is changed by the color tone correction, the proportion of advancing colors and receding colors in the moving subject is changed, and the sense of speed of the moving image is enhanced or reduced.

FIG. 16 is a view of explaining color tone correction processing. The image processing unit 34d recognizes and detects the trees 52 from the image 50 as moving subjects, as in the second embodiment. The image processing unit 34d executes the same color tone correction processing as that of the sixth embodiment on a region 90 including trees 52. That is, the image processing unit 34d corrects the color tone of the moving subject. The fact that the tone curve used for color tone correction is different depending on the moving velocity V of the camera 1 is the same as in the sixth embodiment.

As described above, the image processing unit 34d reduces the proportion of advancing colors in the moving subject as the moving velocity V of the camera 1 decreases. In other words, the image processing unit 34d increases the proportion of advancing colors in the moving subject as the moving velocity V of the camera 1 increases. Thus, the sense of speed experienced by the viewer from the reproduced moving image can be brought closer to the sense of speed actually experienced by the skier.

Note that if it is desired to allow the viewer to always experience a sense of speed above a certain velocity during reproduction of a moving image, regardless of the velocity during image-capturing, the proportion of advancing colors in the moving subject may be reduced as the moving velocity V increases. In other words, as the moving velocity V decreases, the proportion of advancing colors in the moving subject may be increased.

Note that a process of replacing a predetermined color may be executed, instead of the color tone correction processing. For example, the sense of speed of the moving image may be adjusted by replacing a predetermined red color with a more bluish color in the moving subject or vice versa to change the proportion of advancing colors and receding colors in the moving subject.

Note that separately from the moving subject, a non-moving subject may be recognized and detected so that the color tone correction may be separately performed on the moving subject and the non-moving subject. For example, when intensifying advancing colors of the moving subject, advancing colors of the non-moving subject may be diminished or receding color may be intensified. In contrast thereto, when intensifying receding colors of the moving subject, advancing colors of the non-moving subject may be intensified or receding color may be diminished. Additionally, a non-moving subject may be recognized and detected so that color tone correction is performed only on the non-moving subject.

The camera 1 according to the seventh embodiment has the following operational advantages, in addition to operational advantages of the camera 1 according to the fifth embodiment.

(1) The image processing unit 34d controls color information of an image-capturing signal based on a recognition result of a subject. Thereby, the sense of speed may be enhanced and lowered particularly for a specific subject to effectively represent a moving image.

### Eighth Embodiment

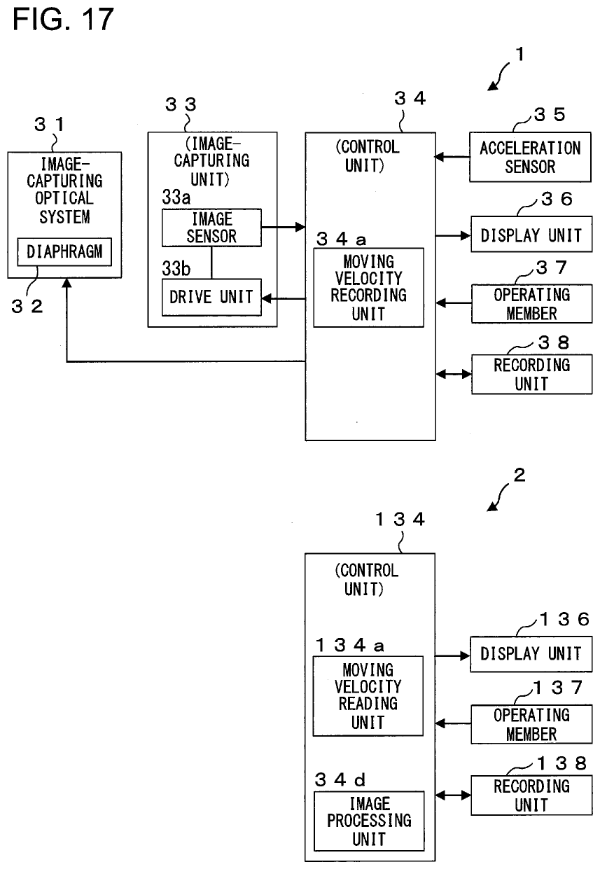

An eighth embodiment will be described with reference to FIG. 17. In the following description, the same components as those in the first embodiment are designated by the same reference numerals, and differences will mainly be described. Features not specifically described are the same as in the first embodiment.

FIG. 17 is a block diagram showing a configuration of a digital camera and a personal computer as an example of the image-capturing device and the image processing apparatus according to the present embodiment. In the eighth embodiment, a personal computer 2 is provided in addition to the camera 1. The personal computer 2 afterwards executes the same image processing (for example, compression processing) as that of the first embodiment on moving image data captured by the camera 1.

The control unit 34 of the camera 1 has a moving velocity recording unit 34a. The moving velocity recording unit 34a calculates the moving velocity of the camera 1 in the same manner as the moving velocity calculation unit 34b according to the first embodiment. The moving velocity recording unit 34a records velocity information indicating the calculated moving velocity in a recording medium including a memory card (not shown) and the like. This recording medium may be the same recording medium as the recording medium on which image data and the like are recorded, or may be a different recording medium.

The personal computer 2 includes a control unit 134, a display unit 136, an operation member 137, and a recording unit 138. The control unit 134 is constituted of a CPU, for example, and controls the overall operation of the personal computer 2.

The control unit 134 includes a moving velocity reading unit 134a and an image processing unit 34d in the same manner as in the first to seventh embodiments. The units are implemented in software by the control unit 134 executing program stored in a nonvolatile memory (not shown). Note that these units may be constituted of an ASIC and the like.

The moving velocity reading unit 134a reads the moving velocity of the camera 1 during capturing the moving image, which is recorded by the camera 1, from a recording medium including a memory card (not shown). The image processing unit 34d performs image processing on the image data read from the recording medium, as in the first embodiment and the like.

The display unit 136 reproduces and displays images processed by the image processing unit 34d, images read by the recording unit 138, and the like. The display unit 136 displays an operation menu screen and the like.

The operation member 137 includes various operation members such as a keyboard and a mouse. The operation member 137 sends operation signals corresponding to operations to the control unit 134. The operation member 137 includes a touch operation member provided on a display surface of the display unit 136.

In accordance with the instruction from the control unit 134, the recording unit 138 records image data subjected to image processing and the like in a recording medium including a memory card (not shown) and the like. The recording unit 38 reads the image data and the like recorded in the recording medium in accordance with the instruction from the control unit 34.

The camera 1 and the personal computer 2 configured as described above can achieve the same operational advantages as those of the first embodiment and the like. Note that the camera 1 may have a function of the personal computer 2. That is, the camera 1 may include the image processing unit 34d, and image processing may be afterwards executed on the captured moving image data. Further, transfer of moving image data and velocity information from the camera 1 to the personal computer 2 may be performed by wired or wireless data communication, rather than via a recording medium (not shown).

The following modifications are also included within the scope of the present invention, and one or more of the modifications may be combined with the above-described embodiment.

### First Modification

The first to fourth embodiments described above may be combined with the fifth to seventh embodiments. For example, by applying both the compression processing and the color tone correction processing, the sense of speed may be more flexibly adjustable. Additionally, only when application of one type of processing does not provide a sufficient sense of speed, the other type of processing may be applied. Moreover, the first to fourth embodiments and the fifth to seventh embodiments may be combined as desired.

Further, a plurality of embodiments among the first to fourth embodiments may be combined. For example, after applying the compression processing, the trimming processing may be further applied. Conversely, after applying the trimming processing, the compression processing may be further applied.

### Second Modification

In each embodiment described above, a moving subject is detected and used. However, when there are a plurality of moving subjects, a subject having a larger difference between frames may be preferentially used.

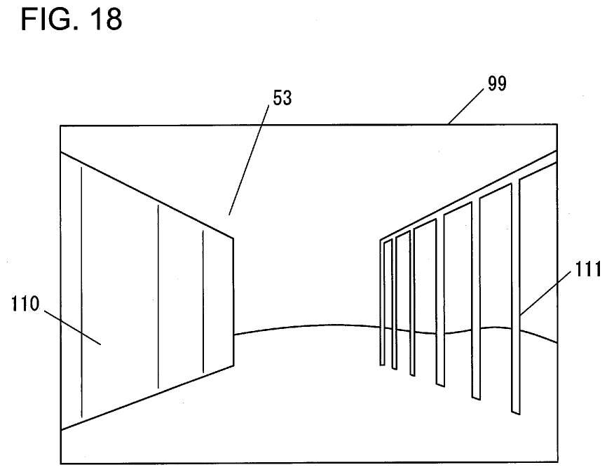

FIG. 18 is a view schematically showing a comparative example of moving subjects. In an image 99 shown in FIG. 18, a plate wall 110 is present on the left side, and a fence 111 is present on the right side. A surface of the plate wall 110 is uniform and has a small contrast. That is, a difference of the plate wall 110 between the frames is small. In other words, between the frames, a reduced sense of speed is experienced from the plate wall 110. On the other hand, the fence 111 has a large contrast. That is, a difference of the fence 111 is large between frames. In other words, between the frames, an enhanced sense of speed is experienced from the fence 111.

Thus, even if a subject having a small surface contrast actually moves at a high speed, a reduced sense of speed is experienced from the subject. Therefore, in the case of FIG. 18, it is desirable to trim or crop the fence 111 in preference to the plate wall 110. For example, for trimming, the trimming may be performed to go around a part including the fence 111, so that the fence 111 is not deleted by trimming. For cropping, the cropping may be performed in a manner that the fence 111 is widely included so that the fence 111 is not deleted by the cropping.

### Third Modification

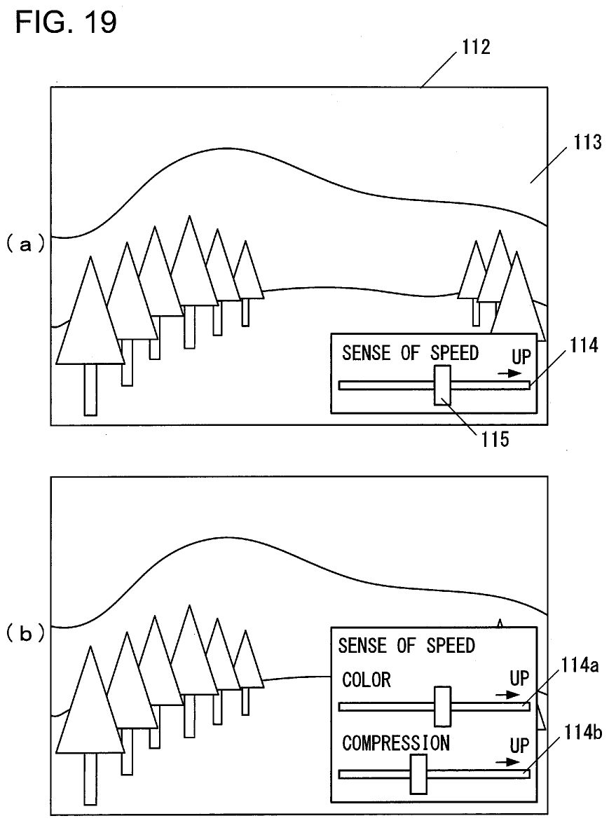

When image processing is performed afterwards as in the eighth embodiment, a user may be able to adjust the intensity of the sense of speed. For example, as illustrated in FIG. 19(a), a user interface 114 (UI 114) for adjusting a sense of speed is displayed on the display screen 112 so that the UI 114 is superimposed on the image 113 being reproduced. The UI 114 is a so-called slider, and the user can move a knob 115 to the left or to the right by touch operation or the like. When the knob 115 is moved to the right, the image processing unit 34d performs image processing so that the sense of speed is enhanced. When the knob 115 is moved to the left, the image processing unit 34d performs image processing so that the sense of speed is lower. Note that, instead of the UI 114, an operation member such as a physical switch or slider may be used.

The image processing unit 34d adjusts the intensity of the sense of speed in accordance with a movement amount of the knob 115. For example, when the knob 115 is largely moved to the right, image processing is performed so that a moving image being reproduced provides an enhanced sense of speed compared with when the knob 115 is slightly moved to the right.

When the moving velocity V of the camera 1 during image-capturing is different, the image processing unit 34d performs different image processing even if the movement amount of the knob 115 is the same. For example, when the image processing unit 34d performs compression processing, the compression processing is performed to a larger degree as the moving velocity V increases, even if the movement amount of the knob 115 is the same. That is, the image processing unit 34d appropriately adjusts the intensity of the image processing so that the movement amount of the knob 115 corresponds to the intensity of the sense of speed experienced from the moving image. Note that the compression processing may be performed in a larger degree as the moving velocity V decreases.

Further, in the above-described embodiments, an approach of adjusting the sense of speed by changing a color of an image and an approach of adjusting the sense of speed by other methods (a method using compression processing, trimming processing, cropping processing, and the like). They may be combined together. For example, as illustrated in FIG. 19(b), the UI 114a indicating color and the UI 114b indicating compression may be displayed separately. When the UI 114a is operated, the image processing unit 34d changes properties of white balance adjustment and tone correction of the image. When the UI 114b is operated, the image processing unit 34d changes properties of compression processing, trimming processing, and cropping processing of the image.

### Fourth Modification

In each embodiment described above, the moving velocity calculation unit 34b of the control unit 34 calculates the moving velocity V of the camera 1 from the acceleration of the camera 1 detected by the acceleration sensor 35. In a fourth modification, a distance to a subject is calculated from a defocus amount determined based on a signal from an image sensor, to determine a moving velocity of the camera 1 from a change in the calculated distance to the subject.

In the camera 1 according to the fourth modification, the image sensor 33a is an image sensor that can perform ranging by an image plane phase difference scheme. The control unit 34 calculates a defocus amount by a pupil division type phase difference detection scheme using a signal from the image sensor 33a and calculates a distance to a subject based on the calculated defocus amount. Then, the control unit 34 calculates a relative velocity between the subject and the camera 1 based on a change in the calculated distance to the subject, and sets the calculated relative velocity as the moving velocity V of the camera 1.

### Fifth Modification

In the above-described embodiments, the acceleration sensor 35 is used to calculate the moving velocity V of the camera 1. In a fifth modification, a so-called TOF (time of flight) sensor is used instead of the acceleration sensor 35.

The TOF sensor is an image sensor used for a known TOF method. The TOF method involves a technique of emitting a light pulse (irradiation light) from a light source unit (not shown) toward a subject and detecting a distance to a subject based on a time until the light pulse reflected from the subject returns to a TOF sensor. The control unit 34 calculates a relative velocity between the subject and the camera 1 based on a change in the detected distance to the subject, and sets the calculated relative velocity as the moving velocity V of the camera 1.

Note that the image sensor 33a may be utilized for the TOF sensor.

### Sixth Modification

In the above-described embodiments, the acceleration sensor 35 is used to calculate the moving velocity V of the camera 1. In a sixth modification, a GPS sensor is used instead of the acceleration sensor 35.

For example, if information outputted by the GPS sensor includes information on the moving velocity, the control unit 34 treats the information on the moving velocity outputted from the GPS sensor as information on the moving velocity V of the camera 1. For example, if information outputted by the GPS sensor does not include information on the moving velocity, the moving velocity calculation unit 34b of the control unit 34 calculates the moving velocity V of the camera 1 based on a change in information on a current position outputted by the GPS sensor.

Although the moving velocity of the camera 1 is described as an example of the velocity information in the above-described embodiments, the velocity information is not limited to the moving velocity of the camera 1. For example, the velocity information may be information on the distance between the camera 1 and a specific target. This is because the change amount of the distance to a specific target changes as the velocity of the camera 1 increases. Specifically, the camera 1 changes image processing based on a magnitude (change amount, change rate) of a change in the distance between the camera 1 and the specific target.

In such an example, the control unit 34 acquires information on the distance from the camera 1 to the specific target. For example, the distance information may be acquired (calculated) from the defocus amount or may be calculated from an output of the TOF sensor as described above.

In the above-described embodiments, the moving velocity of the camera 1 has been described as an example of the velocity information; however, the velocity information is not limited to the moving velocity of the camera 1. For example, the velocity information may be information on a size of a specific target. This is because the change amount of the size of the specific target changes as the velocity of the camera 1 increases. Specifically, the camera 1 changes image processing based on a magnitude (change amount, change rate) of a change in the size of the specific target.

In such an example, the control unit 34 acquires information on a size of a photographed specific target. The size information may be acquired by using subject recognition (object recognition) technique and edge extraction technique.

In the above-described embodiments, the moving velocity of the camera 1 has been described as an example of the velocity information; however, the velocity information is not limited to the moving velocity of the camera 1. For example, the velocity information may be sound volume. This is because sound volume (in particular, wind noise volume) to be acquired becomes larger as the velocity of the camera 1 increases. Specifically, the camera 1 changes image processing based on sound volume acquired during photographing.

In such an example, the control unit 34 acquires information on sound volume during photographing. The sound volume information may be acquired by photographing and analyzing recorded sound. Further, the control unit 34 may acquire information on sound volume in a specific frequency band corresponding to wind noise.

### Seventh Modification

In a seventh embodiment, an example has been described in which the color tone correction processing is executed on a part of an image. In the seventh embodiment, a part of the image is a moving subject; however, color tone correction processing may be executed on a part different from this. For example, a sensor for detecting a line of sight of a skier wearing the camera 1 is provided on goggles worn by the skier, for example. The camera 1 performs color tone correction processing on a subject present in the line-of-sight direction detected by the sensor. Instead of the line of sight of the skier wearing the camera 1, a line of sight of a person around the skier, such as a companion of the skier, may be used.

Further, line-of-sight information regarding the line-of-sight detected by the sensor may be recorded together with the image data, and color tone correction processing using the line-of-sight information may be executed afterwards (eighth embodiment). Furthermore, during reproduction of a moving image, a line of sight of a viewer who views the moving image may be detected and color tone correction processing may be performed on a subject existing ahead of the line of sight.

### Eighth Modification

In the seventh embodiment, an example has been described in which color tone correction processing is executed on a part of an image. When processing on a part of an image is executed, a color component to be changed in its intensity may be changed based on a recognition result of a subject. Here, an example will be described in which advancing colors are intensified. For example, when the face of a person appears in an image, the face region of the person is identified by a subject recognition technique. Then, the face region of the person may be adjusted so that the red component is not intensified and orange component, which is another advancing color, is intensified. This is because a large change in the color of the skin color region such as the face may cause unnaturalness. In this way, a color whose proportion is to be increased may be changed between a case where the image processing unit 34d recognizes a part having the specific color and a case where the image processing unit 34d does not recognize such a part. This enables the sense of speed to be adjusted without breaking the appearance of the image.

Although various embodiments and modifications have been described in the above description, the present invention is not limited thereto. Other aspects contemplated within the technical idea of the present invention are also included within the scope of the present invention.

The disclosure of the following priority application is herein incorporated by reference:

Japanese Patent Application No. 2017-71951 (filed Mar. 31, 2017)

### REFERENCE SIGNS LIST

1 . . . camera, 31, 31A . . . image-capturing optical system, 32 . . . diaphragm, 33a . . . image sensor, 34, 134 . . . control unit, 34b . . . moving velocity calculation unit, 34d . . . image processing unit

1. An electronic device that performs image-capturing and generates a moving image, the electronic device comprising:
an image sensor that captures an image of a subject and outputs the moving image; and
a generating unit that changes an image-capturing region of the image sensor generating the moving image to be displayed on a display unit, based on information on movement of the electronic device.

2. The electronic device according to claim 1, wherein:
the generating unit generates the moving image of a second image-capturing region smaller than a first image-capturing region, if a moving velocity of the electronic device based on the information represents a second velocity higher than a first velocity.

3. The electronic device according to claim 2, wherein:
the generating unit generates the moving image of a fourth image-capturing region larger than a third image-capturing region, if the moving velocity of the electronic device based on the information represents a fourth velocity lower than a third velocity.

4. The electronic device according to claim 3, wherein:
the generating unit generates the moving image of a smaller image-capturing region as the moving velocity of the electronic device based on the information increases.

5. The electronic device according to claim 4, wherein:
the generating unit generates the moving image of a larger image-capturing region as the moving velocity of the electronic device based on the information decreases.

6. The electronic device according to claim 1, wherein:
the generating unit changes the image-capturing region displayed on the display unit to enhance a sense of speed of a moving image to be reproduced.

7. An electronic device that performs image-capturing and generates a moving image, the electronic device comprising:
an image sensor that captures an image of a subject and outputs moving image data; and
a generating unit that generates a moving image to be displayed on a display unit by compressing an image constituting the moving image based on the moving image data in at least one of a vertical direction and a horizontal direction, based on information on movement of the electronic device.

8. The electronic device according to claim 7, comprising:
a recognition unit that recognizes a subject, wherein:
the generating unit generates the moving image based on a recognition result of the recognition unit.

9. The electronic device according to claim 8, wherein:
the generating unit determines a region, in which an image constituting the moving image is compressed, based on the recognition result of the recognition unit.

10. The electronic device according to claim 8, wherein:
the recognition unit recognizes a moving object that moves relative to the electronic device by movement of the electronic device; and
the generating unit generates the moving image based on a position of the moving object.

11. The electronic device according to claim 7, wherein:
the generating unit generates the moving image with a second compression amount larger than a first compression amount, if a moving velocity of the electronic device based on the information represents a second velocity higher than a first velocity.

12. The electronic device according to claim 7, wherein:
the generating unit generates the moving image with a fourth compression amount smaller than a third compression amount, if the moving velocity of the electronic device based on the information represents a fourth velocity lower than a third velocity.

13. The electronic device according to claim 7, wherein:
the generating unit performs the compression to enhance a sense of speed of a moving image to be reproduced.

14. An electronic device that processes a captured moving image, the electronic device comprising:
a reading unit that reads moving image data; and
a generating unit that generates a moving image by processing the moving image data so as to change a display region of the moving image to be displayed on a display unit based on information on movement of the electronic device.

15. An electronic device that processes a captured moving image, the electronic device comprising:
a reading unit that reads moving image data; and
a generating unit that generates a moving image to be displayed on a display unit by compressing an image constituting the moving image based on the moving image data in at least one of a vertical direction and a horizontal direction, based on information on movement of the electronic device.

16. A program executed by an electronic device that processes a captured moving image, the program executing:
a first procedure of reading moving image data; and
a second procedure of generating a moving image by processing the moving image data so as to change a display region of the moving image to be displayed on a display unit based on information on movement of the electronic device.

17. A program executed by an electronic device that processes a captured moving image, the program executing:
a first procedure of reading moving image data; and
a second procedure of generating a moving image to be displayed on a display unit by compressing an image constituting the moving image based on the moving image data in at least one of a vertical direction and a horizontal direction, based on information on movement of the electronic device.

18. An electronic device that generates moving image data, the electronic device comprising:
an image sensor that captures a subject and outputs moving image data; and
a control unit that controls an image-capturing region of the image sensor based on information on movement of the electronic device.

19. An electronic device comprising:
an image sensor that captures an image of a subject and outputs a moving image; and
a generating unit that changes an image-capturing region of the image sensor generating the moving image according to whether a change in a size of a specific subject in the moving image has a first amount or a second amount.
